(19) United States
(12) Patent Application Publication
(10) Pub. No.: US 2021/0041637 A1
(43) Pub. Date: Feb. 11, 2021

(54) OPTICAL CONNECTOR AND METHOD FOR MANUFACTURING SAME

(71) Applicant: SUMITOMO ELECTRIC INDUSTRIES, LTD., Osaka (JP)

(72) Inventor: Tetsu MORISHIMA, Osaka-shi (JP)

(73) Assignee: SUMITOMO ELECTRIC INDUSTRIES, LTD., Osaka (JP)

(21) Appl. No.: 17/081,336

(22) Filed: Oct. 27, 2020

Related U.S. Application Data
(63) Continuation of application No. PCT/JP2019/048547, filed on Dec. 11, 2019.

(30) Foreign Application Priority Data
Jan. 8, 2019 (JP) 2019-001142

(51) Int. Cl. G02B 6/38

(52) U.S. Cl. CPC G02B 6/3861; G02B 6/3863; G02B 6/3834

(57) ABSTRACT

An optical connector includes: an optical fiber including a glass fiber and a resin coating that covers the glass fiber, an end portion of the glass fiber being exposed from the resin coating; a ferrule including a through hole and holding the optical fiber in a state where the end portion of the glass fiber exposed from the resin coating is inserted into the through hole; a thermosetting resin provided between an inner wall of the through hole and the glass fiber, the thermosetting resin adhering the glass fiber and the ferrule to each other; and an ultraviolet curable resin provided in a range which is between the inner wall of the through hole and the glass fiber and includes a tip of the ferrule, the ultraviolet curable resin adhering the glass fiber and the ferrule to each other.

### CROSS-REFERENCE TO RELATED APPLICATION(S)

This application is a continuation of PCT application No. PCT/JP19/048547, which was filed on Dec. 11, 2019 based on Japanese Patent Application No. 2019-001142 filed on Jan. 8, 2019, the contents of which are incorporated herein by reference.

### TECHNICAL FIELD

The present disclosure relates to an optical connector and a method for manufacturing the same.

### BACKGROUND ART

Construction of an optical network makes a progress in order to cope with increase in communication speed and increase in amount of information by the spread of information communication such as the Internet and also bidirectional communication and large-capacity communication. As a method for increasing a transmission capacity of an optical fiber, for example, a multi-core fiber (hereinafter, referred to as an “MCF”) including a plurality of cores is proposed. When the optical network is constructed with the MCF, an optical connector for easily splicing the MCF is required. At that time, in order to splice all the cores of the MCF, it is required to rotate the MCF around its central axis to align a position of the MCF in a rotation direction (rotationally align).

Patent Literature 1 discloses a manufacturing method including rotational alignment of the optical connector for splicing the MCF. In this manufacturing method, first, the MCF fixed to a ferrule is arranged so that a master MCF faces a fixed master MCF connector, and center positions of the MCF fixed to the ferrule and the master MCF are aligned. Next, light is introduced into a core of one of the master MCF and the MCF, and the ferrule is rotated relative to the master MCF connector such that light is detected from a core of the other of the master MCF and the MCF, and the ferrule is held at a position where light intensity is maximum. After that, a flange including a positioning mechanism is fixed to the ferrule of the MCF that is rotationally aligned.

### CITATION LIST

### Patent Literature

Patent Literature 1: JP-A-2013-238692

### SUMMARY OF INVENTION

### Solution to Problem

One aspect of the present disclosure is an optical connector including:

an optical fiber including a glass fiber and a resin coating that covers the glass fiber, an end portion of the glass fiber being exposed from the resin coating;

a ferrule including a through hole and holding the optical fiber in a state where the end portion of the glass fiber exposed from the resin coating is inserted into the through hole;

a thermosetting resin provided between an inner wall of the through hole and the glass fiber, the thermosetting resin adhering the glass fiber and the ferrule to each other; and

an ultraviolet curable resin provided in a range which is between the inner wall of the through hole and the glass fiber and includes a tip of the ferrule, the ultraviolet curable resin adhering the glass fiber and the ferrule to each other.

Another aspect of the present disclosure is a method for manufacturing an optical connector that includes: an optical fiber including a glass fiber and a resin coating that covers the glass fiber, an end portion of the glass fiber being exposed from the resin coating; and a ferrule including a through hole and holding the end portion of the optical fiber, the method for manufacturing including:

coating an inner wall of the through hole with a thermosetting resin;

inserting the glass fiber into the through hole so that a part of the end portion of the glass fiber exposed from the resin coating protrudes from a tip of the ferrule;

performing rotational alignment of the optical fiber;

coating the tip of the ferrule with an ultraviolet curable resin;

curing the ultraviolet curable resin;

curing the thermosetting resin; and

polishing the part of the end portion of the glass fiber protruding from the tip of the ferrule.

### BRIEF DESCRIPTION OF DRAWINGS

FIG. 1 is an external perspective view of an optical connector according to the present disclosure.

FIG. 2 is a perspective view of a ferrule of the optical connector of FIG. 1.

FIG. 3 is a cross-sectional view illustrating a state after the ferrule of FIG. 2 is housed in a plug frame.

FIG. 4 is a flow chart illustrating a method for manufacturing the optical connector of the present disclosure.

FIG. 5A is a diagram illustrating one manufacturing step (optical fiber insertion step) of the optical connector of the present disclosure.

FIG. 5B is a diagram illustrating one manufacturing step (rotational alignment step) of the optical connector of the present disclosure.

FIG. 5C is a diagram illustrating one manufacturing step (ultraviolet curable resin coating step) of the optical connector of the present disclosure.

FIG. 5D is a diagram illustrating one manufacturing step (polishing step) of the optical connector of the present disclosure.

FIG. 6 is a diagram illustrating a bundle fiber.

### DESCRIPTION OF EMBODIMENTS

### Description of Embodiments of the Present Disclosure

First, contents of the embodiments of the present disclosure will be listed and described.

(1) An optical connector according to the embodiment of the present disclosure includes:

an optical fiber including a glass fiber and a resin coating that covers the glass fiber, an end portion of the glass fiber being exposed from the resin coating;

a ferrule including a through hole and holding the optical fiber in a state where the end portion of the glass fiber exposed from the resin coating is inserted into the through hole;

a thermosetting resin provided between an inner wall of the through hole and the glass fiber, the thermosetting resin adhering the glass fiber and the ferrule to each other; and

an ultraviolet curable resin provided in a range which is between the inner wall of the through hole and the glass fiber and includes a tip of the ferrule, the ultraviolet curable resin adhering the glass fiber and the ferrule to each other.

Accordingly, the rotation of the glass fiber near the tip of the ferrule due to the reduction of the twisting of the optical fiber is suppressed, thereby making it possible to improve accuracy of a core position of the optical connector.

(2) The thermosetting resin and the ultraviolet curable resin may be provided within the range including the tip of the ferrule in a state of being mixed with each other. Accordingly, even when the ultraviolet curable resin is mixed with the thermosetting resin, the glass fiber adheres to the ferrule by the ultraviolet curable resin near the tip of the ferrule, such that it is possible to obtain an optical connector in which the rotation of the glass fiber near the tip of the ferrule is suppressed. A splicing loss of the optical connector can be reduced.

(3) The optical fiber may be any one of a multi-core fiber, a polarization maintaining fiber, and a bundle fiber. Accordingly, in addition to the multi-core fiber, even when the polarization maintaining fiber and the bundle fiber are used, it is possible to prevent the rotation of the glass fiber near the tip of the ferrule, thereby making it possible to prevent increase in the splicing loss of the optical connector.

(4) A length of the range including the tip of the ferrule may be 50 μm or more and 200 μm or less.

(5) A method for manufacturing an optical connector according to the embodiment of the present disclosure is a method for manufacturing an optical connector that includes: an optical fiber including a glass fiber and a resin coating that covers the glass fiber, an end portion of the glass fiber being exposed from the resin coating; and a ferrule including a through hole and holding the end portion of the optical fiber, the method for manufacturing including:

coating an inner wall of the through hole with a thermosetting resin;

inserting the glass fiber into the through hole so that a part of the end portion of the glass fiber exposed from the resin coating protrudes from a tip of the ferrule;

performing rotational alignment of the optical fiber;

coating the tip of the ferrule with an ultraviolet curable resin;

curing the ultraviolet curable resin;

curing the thermosetting resin; and

polishing the part of the end portion of the glass fiber protruding from the tip of the ferrule.

Accordingly, the rotation of the glass fiber near the tip of the ferrule due to the reduction of the twisting of the optical fiber is suppressed, thereby making it possible to improve accuracy of a core position of the optical connector.

(6) The method for manufacturing may further include pulling back the glass fiber protruding from the tip of the ferrule toward the ferrule after the coating of the ultraviolet curable resin.

Accordingly, since the ultraviolet curable resin can be surely provided in the through hole near the tip of the ferrule, the rotation of the optical fiber near the tip of the ferrule can be surely suppressed.

(7) In the polishing of the part of the end portion of the glass fiber, the part of the end portion of the glass fiber and the ferrule may be polished so that an end surface of the glass fiber and a tip surface of the ferrule are flush with each other.

### Details of Embodiments of the Present Invention

Hereinafter, a preferred embodiment of an optical connector and a method for manufacturing the same according to the present disclosure will be described with reference to the drawings. The present invention is not limited to the following example but is indicated by the scope of the claims, and is intended to include all the modifications within meanings equivalent to the scope of the claims and within the scope thereof. The present invention includes a combination of any embodiments as long as a plurality of embodiments can be combined with each other. In the following description, configurations denoted by the same reference signs even in different drawings are regarded as the same configurations, and the description thereof may be omitted.

Although the rotational alignment is performed after the MCF is fixed to the ferrule, and then the flange is fixed thereto in the manufacturing method disclosed in Patent Literature 1, there is a method in which the MCF is inserted into the ferrule including the flange, the MCF is rotated to perform the rotational alignment, and then the MCF is fixed to the ferrule. In this case, a thermosetting resin is used to fix the MCF to the ferrule. However, since a clearance between a through hole of the ferrule and the MCF is less than 1 μm which is significantly small, when the MCF is rotationally aligned in a state of being twisted inside the ferrule, this twist is reduced during the curing time of the thermosetting resin, generally in approximately 30 to 60 minutes, and thus the MCF may deviate from a predetermined rotation angle at a tip portion of the ferrule.

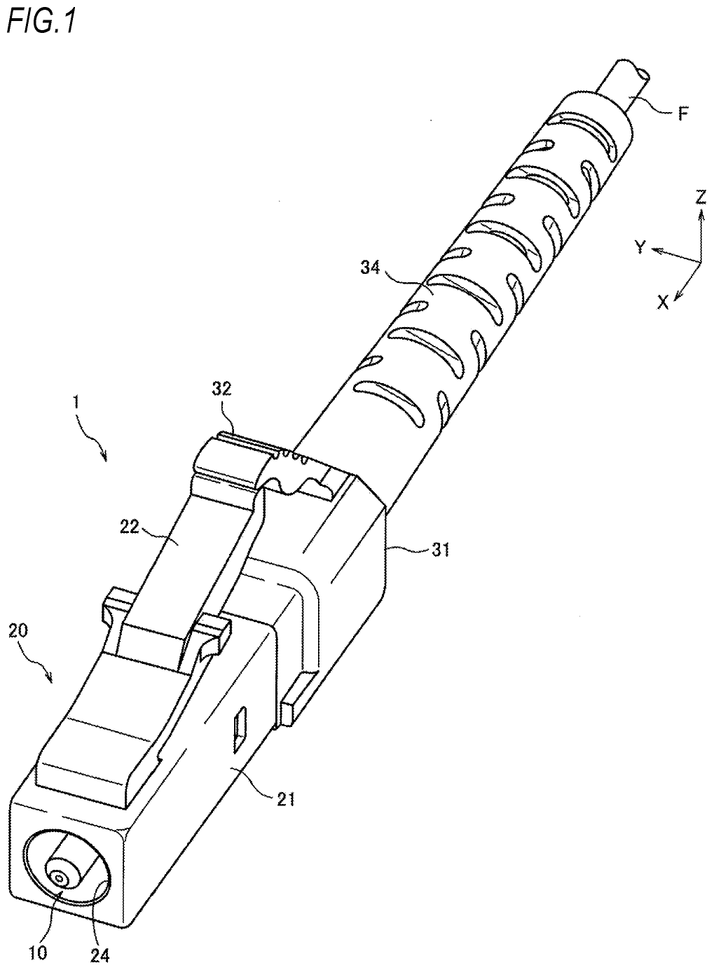

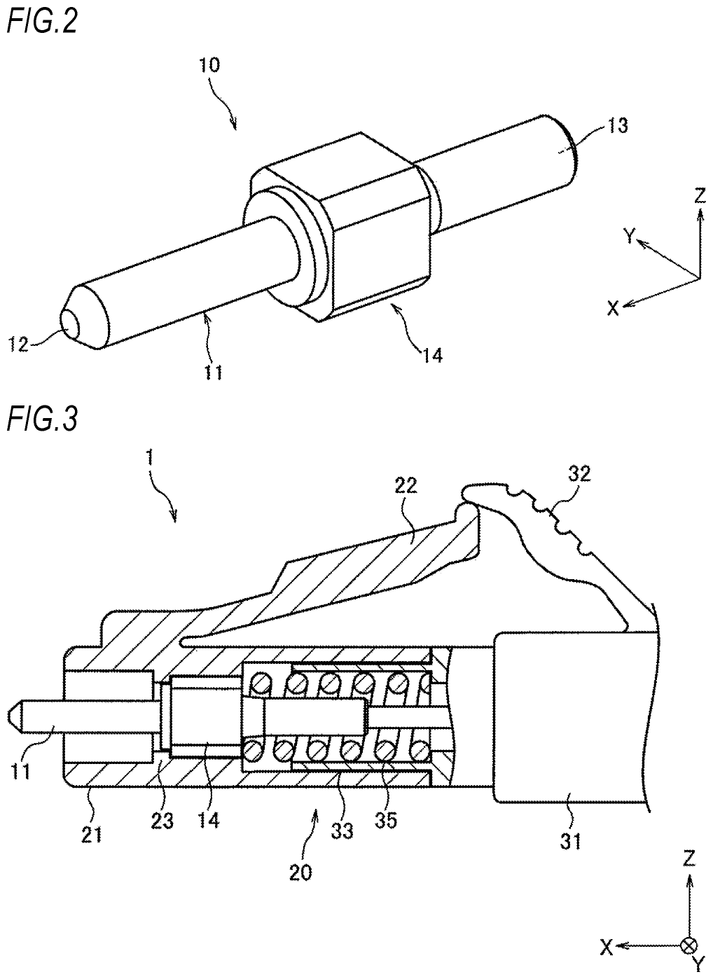

FIG. 1 is an external perspective view of an optical connector 1 according to one aspect of the present disclosure, FIG. 2 is a perspective view of a ferrule 10 of the optical connector 1, and FIG. 3 is a cross-sectional view illustrating a state after the ferrule 10 is accommodated in a plug frame. In the following embodiments, an LC connector will be described as an example of the optical connector, but for example, the present invention can also be applied to other types of optical connectors including an SC connector and an MU connector.

The optical connector 1 includes the plug frame 20 that accommodates the ferrule 10, and a boot 34 that protects the optical fiber F is provided at a rear end of the plug frame 20. The ferrule 10 includes the ferrule body 11 extending in an X-axis direction illustrated in the drawing. The ferrule body 11 is, for example, a cylindrical component made of zirconia, and a through hole in the X-axis direction is provided inside the ferrule body 11 and holds a glass fiber exposed from a resin coating at a tip portion of the optical fiber F. The optical fiber F is, for example, the MCF including a plurality of cores, and is inserted from the side of a rear end 13 of the ferrule 10. A tip surface of the optical fiber F is exposed from a front end 12, and the optical fiber F is fixed to the ferrule 10 in a state where a plurality of cores are arranged at predetermined positions around a central axis of the ferrule 10. The X-axis direction illustrated in the drawing corresponds to an optical axis direction of the optical fiber F.

A metallic flange 14 is provided on the outside of an approximately central position of the ferrule body 11. In the embodiment, the flange 14 has an approximately quadrangular shape in a cross-sectional view, and a boundary position of each surface thereof is chamfered. The flange 14 has a function of positioning and fixing the ferrule 10 to the plug frame 20 on the basis of any one surface of the flange 14.

The plug frame 20 includes a polygonal tubular front housing 21 extending in the X-axis direction illustrated in the drawing. The front housing 21 is made of, for example, resin, and includes a rear end opening capable of receiving the ferrule 10 including the flange 14, and an opening 24 that allows the front end 12 of the ferrule body 11 to protrude. The front housing 21 has an approximately rectangular tubular shape in a cross-sectional view, and is formed so that the flange 14 of the ferrule 10 inserted into the front housing 21 can be positioned in a YZ direction. A positioning protrusion 23 abutting on a front end surface of the flange 14 is provided. A latch arm 22 having flexibility is provided on an outer peripheral surface of the front housing 21.

The plug frame 20 also includes a rear housing 31 behind the front housing 21. The rear housing 31 is made of, for example, resin, and includes a cylindrical spring housing portion 33 capable of housing a rear end portion of the ferrule 10 and a connector pressing spring 35. The connector pressing spring 35 is arranged at the rear of the ferrule 10, and can energize the ferrule 10 forward (positive direction of the X axis in the drawing, the same applies hereinafter) by abutting on a rear end surface of the flange 14. A clip 32 that can be engaged with the latch arm 22 is provided on an outer peripheral surface of the rear housing 31.

In order to assemble the connector, the rear end portion of the ferrule 10 and the connector pressing spring 35 are accommodated in the rear housing 31, and a tip portion of the ferrule 10 is inserted into the front housing 21. Next, when the clip 32 rides on the latch arm 22, the front housing 21 is latched to the rear housing 31. At the same time, the flange 14 is pushed forward by an energizing force of the connector pressing spring 35. As a result, since the front end surface of the flange 14 abuts on the positioning protrusion 23 of the front housing 21, the ferrule 10 is positioned in the X-axis direction. In this state, the flange 14 moves forward, and the tip portion of the ferrule 10 protrudes from the front housing 21.

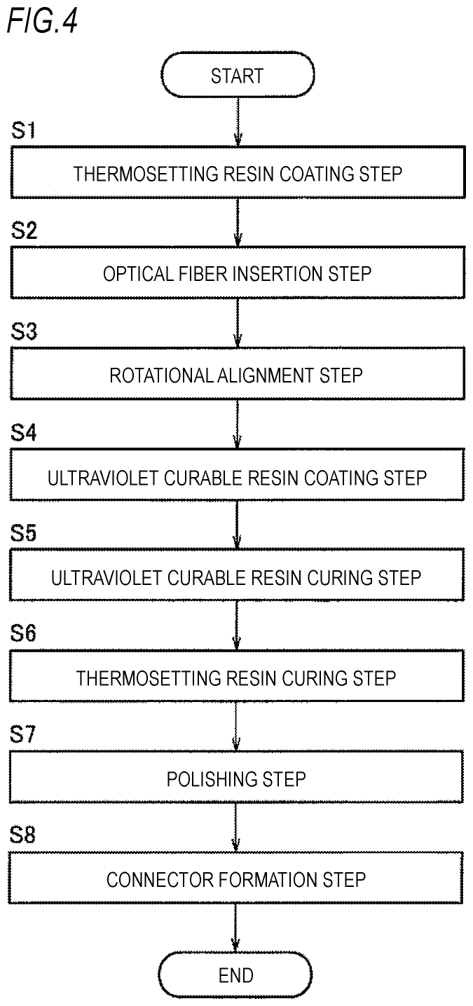

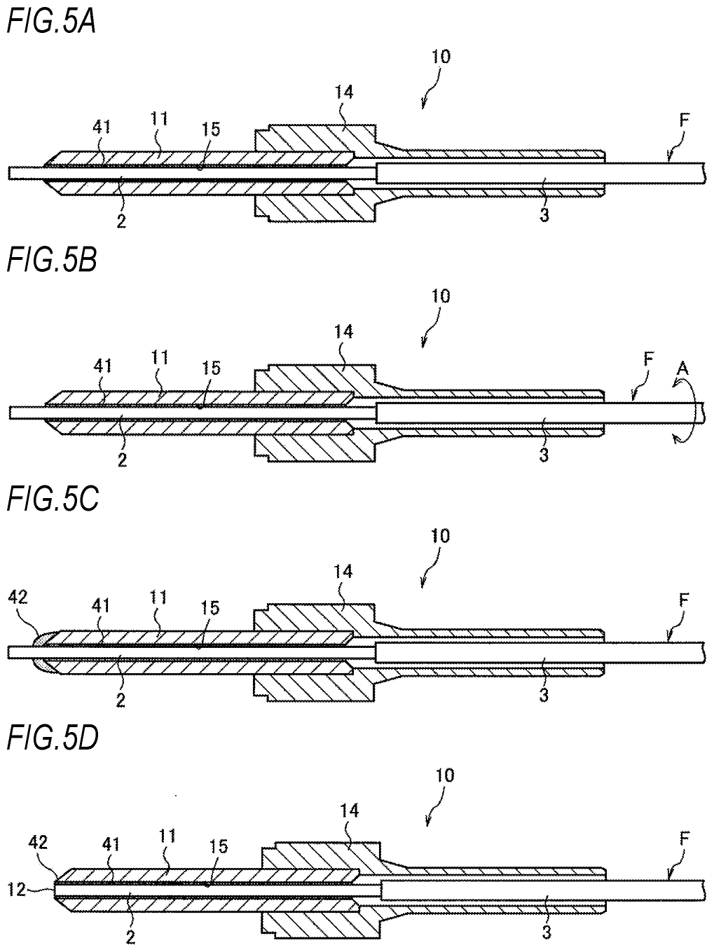

Next, a method for positioning and fixing the optical fiber F to the ferrule 10 will be described. FIG. 4 is a flowchart illustrating a method for manufacturing the optical connector, and FIGS. 5A to 5D are diagrams illustrating an optical fiber insertion step, a rotational alignment step, an ultraviolet curable resin coating step, and a polishing step, each of which is one manufacturing step of the optical connector. In FIGS. 5A to 5D, a gap between the optical fiber F and the ferrule body is schematically illustrated so that the gap therebetween can be seen.

First, the ferrule 10 including the flange 14 is prepared, and an inner wall of a through hole 15 of the ferrule body 11 is coated with a thermosetting resin 41 (thermosetting resin coating step in step S1). Next, as illustrated in FIG. 5A, the glass fiber 2 is exposed by stripping a resin coating 3 from the optical fiber F, and the glass fiber 2 is inserted into the through hole 15 of the ferrule 10 from the rear end portion thereof (negative side in the X-axis direction) (optical fiber insertion step in step S2). Here, a clearance (gap) between the glass fiber 2 and the inner wall of the through hole 15 of the ferrule body 11 is approximately less than 1 μm. As illustrated in FIG. 5A, in a single-core connector, the optical fiber F is inserted so that the glass fiber 2 protrudes several mm from the tip of the ferrule 10.

Next, as illustrated in FIG. 5B, the rotational alignment of the optical fiber F is performed (rotational alignment step in step S3). The rotational alignment is performed by rotating the glass fiber 2 in a direction of an arrow A with a predetermined surface on the outer peripheral side of the flange 14 as a reference surface, so that the glass fiber 2 at the tip portion becomes a predetermined rotation angle. As a specific method of the rotational alignment, for example, the method disclosed in Patent Literature 1 or various existing methods can be adopted. In the rotational alignment step, since the glass fiber 2 is rotated in the through hole 15 of the ferrule body 11, stress caused by the rotation of the glass fiber 2 does not work at the tip portion of the glass fiber 2 which protrudes from the ferrule body 11. However, inside the ferrule body 11, since the clearance between the inner wall of the through hole 15 of the ferrule body 11 and the glass fiber 2 is small, the stress caused by the rotation at the time of the rotational alignment remains.

Therefore, when the thermosetting resin 41 is cured in this state, the remaining stress causes the glass fiber 2 to rotate in the ferrule body 11, such that a position of the glass fiber 2 at the tip portion also deviates from a predetermined rotation angle. Therefore, when the optical connector is assembled, a splicing loss of the optical connector increases.

In the embodiment, as illustrated in FIG. 5C, after the rotational alignment in step S3, a periphery of the glass fiber 2 protruding from the tip portion of the ferrule 10 is coated with an ultraviolet curable resin 42 by using, for example, a syringe (ultraviolet curable resin coating step in step S4). In this state, the ultraviolet curable resin 42 which is a liquid penetrates into the through hole 15 from the tip of the ferrule up to a depth of 50 μm to 200 μm, specifically 100 μm, and is mixed with the thermosetting resin 41. Here, the glass fiber 2 may be pulled back from the ferrule body 11 by a predetermined length after the ultraviolet curable resin coating step. As a result, the ultraviolet curable resin 42 can be surely taken in the periphery of the glass fiber 2 in the through hole 15 at the tip portion of the ferrule 10.

After step S4, the ultraviolet curable resin 42 is cured by irradiating the tip portion of the ferrule 10 with ultraviolet rays (ultraviolet curable resin curing step in step S5). The curing of the ultraviolet curable resin 42 causes the glass fiber 2 to adhere to the ferrule 10 at least at the tip portion of the ferrule 10. After that, the ferrule 10 into which the optical fiber F is inserted is heated to cure the thermosetting resin 41 in the ferrule body 11 (thermosetting resin curing step in step S6). When the thermosetting resin 41 is thermoset, it is desirable that a thermal expansion coefficient of the ultraviolet curable resin 42 is equal to or less than 5×10⁻⁵/° C. in order to prevent the rotation of the glass fiber 2 caused by a heat change of the ultraviolet curable resin 42.

Accordingly, in the embodiment, before the thermosetting resin 41 is cured, the glass fiber 2 at the tip portion of the ferrule 10 is temporarily fixed by the ultraviolet curable resin 42, whereby the rotation of the glass fiber at the time of the thermosetting of the thermosetting resin 41 is suppressed. After step S6, as illustrated in FIG. 5D, an end surface of a tip portion of the glass fiber 2 and an end surface of a tip portion of the ferrule body 11 are polished (polishing step in step S7). In the polishing step, for example, the tip of the glass fiber 2 and the tip of the ferrule 10 are polished to be flush with each other. With respect to a longitudinal direction of the glass fiber 2 (X-axis direction), a predetermined angle may be formed or polishing may be performed in a convex spherical shape. In the polishing step, the ferrule body 11 may be polished up to a depth at which a cured portion of the ultraviolet curable resin 42 remains, and in some cases, the ferrule body 11 may be polished up to a depth at which the cured portion of the ultraviolet curable resin 42 is removed.

Next, the ferrule 10 on which the optical fiber F is mounted is combined with the plug frame 20 and the connector pressing spring 35, thereby obtaining the optical connector 1 (connector formation step in step S8). A method for assembling the optical connector 1 is as described above.

In the embodiment described above, while the LC connector is described as an example of the optical connector, the present invention can also be applied to other types of optical connectors including the SC connector and the MU connector. While the optical fiber F is described as an example of the MCF, the optical fiber F of the present invention may be, for example, a polarization maintaining fiber or a bundle fiber. The MCF, the polarization maintaining fiber, and the bundle fiber are optical fibers that require adjustment of the rotation angle around the central axis when optically spliced.

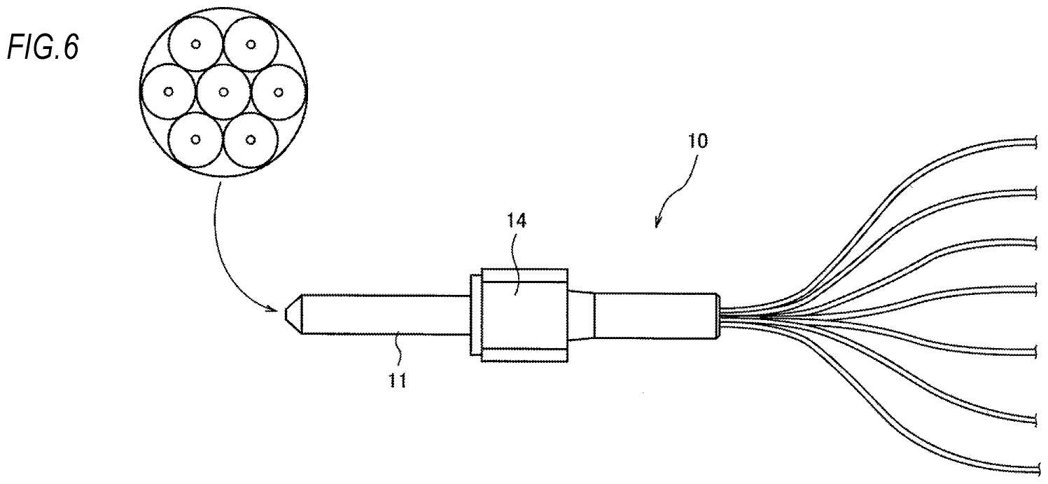

The bundle fiber is a fiber in which a plurality of single-core fibers are collected for being optically spliced to the multi-core fiber. More specifically, for example, a tip of a multi-core fiber having a glass diameter of 125 μm is chemically etched, thereby preparing a multi-core fiber having a reduced glass diameter of, for example, 45 μm, and as illustrated in FIG. 6, a plurality of (for example, seven) pieces are put together with an adhesive and then inserted into the ferrule 10. In the case of this example, the plurality of pieces can be arranged so that a distance between the cores becomes 45 μm. As described above, in the present invention, even when the multi-core fiber, the polarization maintaining fiber, and the bundle fiber are used, the optical fiber can be surely positioned, thereby making it possible to prevent deterioration in the splicing loss.

### REFERENCE SIGNS LIST

1: optical connector
2: glass fiber
3: resin coating
10: ferrule
11: ferrule body
12: front end
13: rear end
14: flange
15: through hole
20: plug frame
21: front housing
22: latch arm
23: positioning protrusion
24: opening
31: rear housing
32: clip
33: spring housing portion
34: boot
35: connector pressing spring
41: thermosetting resin
42: ultraviolet curable resin

1. An optical connector comprising:
an optical fiber including a glass fiber and a resin coating that covers the glass fiber, an end portion of the glass fiber being exposed from the resin coating;
a ferrule including a through hole and holding the optical fiber in a state where the end portion of the glass fiber exposed from the resin coating is inserted into the through hole;
a thermosetting resin provided between an inner wall of the through hole and the glass fiber, the thermosetting resin adhering the glass fiber and the ferrule to each other; and
an ultraviolet curable resin provided in a range which is between the inner wall of the through hole and the glass fiber and includes a tip of the ferrule, the ultraviolet curable resin adhering the glass fiber and the ferrule to each other.

2. The optical connector according to claim 1,
wherein the thermosetting resin and the ultraviolet curable resin are provided within the range including the tip of the ferrule in a state of being mixed with each other.

3. The optical connector according to claim 1,
wherein the optical fiber is any one of a multi-core fiber, a polarization maintaining fiber, and a bundle fiber.

4. The optical connector according to claim 1,
wherein a length of the range including the tip of the ferrule is 50 μm or more and 200 μm or less.

5. A method for manufacturing an optical connector that includes: an optical fiber including a glass fiber and a resin coating that covers the glass fiber, an end portion of the glass fiber being exposed from the resin coating; and a ferrule including a through hole and holding the end portion of the optical fiber, the method for manufacturing comprising:
coating an inner wall of the through hole with a thermosetting resin;
inserting the glass fiber into the through hole so that a part of the end portion of the glass fiber exposed from the resin coating protrudes from a tip of the ferrule;
performing rotational alignment of the optical fiber;
coating the tip of the ferrule with an ultraviolet curable resin;
curing the ultraviolet curable resin;
curing the thermosetting resin; and
polishing the part of the end portion of the glass fiber protruding from the tip of the ferrule.

6. The method for manufacturing the optical connector according to claim 5, further comprising:
pulling back the glass fiber protruding from the tip of the ferrule toward the ferrule after the coating of the ultraviolet curable resin.

7. The method for manufacturing the optical connector according to claim 5,
wherein in the polishing of the part of the end portion of the glass fiber, the part of the end portion of the glass fiber and the ferrule are polished so that an end surface of the glass fiber and a tip surface of the ferrule are flush with each other.
